(19) United States
(12) Patent Application Publication
(10) Pub. No.: US 2026/0357838 A1
(43) Pub. Date: Nov. 12, 2026

(54) QUICK CONNECT SYSTEM FOR T-SLOT BUILDING SYSTEMS AND RELATED METHODS

(71) Applicant: Shaun Morris, Visalia, CA (US)

(72) Inventor: Shaun Morris, Visalia, CA (US)

(21) Appl. No.: 19/201,734

(22) Filed: May 7, 2025

(51) Int. Cl. F16B 12/28

(52) U.S. Cl. CPC F16B 12/28

(57) ABSTRACT

A modular quick connection system is disclosed for joining T-slot framing members in a perpendicular configuration. The system includes a first joining member secured to the end of a first T-slot framing rail and a second joining member configured to be secured along a lateral T-slot channel of a second framing rail. The first and second joining members are coupled via a dovetail sliding interface, enabling rapid mechanical engagement and alignment. One or more securing fasteners are positioned through aligned holes in the joining members to rigidly fix the connection. The second joining member may be attached using T-nuts configured to engage with the T-slot channels of the framing rail. The system is adaptable for single-channel and dual-channel configurations and may be scaled to accommodate multi-slot rail profiles. The invention allows for fast assembly, disassembly, and reconfiguration of structural frameworks using standardized T-slot hardware.

### FIELD OF THE INVENTION

The present invention relates generally to modular structural framing systems and, more particularly, to mechanical connection assemblies for T-slot rail systems. The invention provides a quick-connect mechanism that enables two or more T-slot framing members to be securely joined using an integrated dovetail engagement interface and fastener-based retention, offering improved strength, alignment, and assembly speed in modular construction applications.

### BACKGROUND OF THE INVENTION

T-slot framing systems, often fabricated from extruded aluminum or other rigid materials, are widely used in industrial automation, machine enclosures, laboratory benches, packaging equipment, and other modular support structures. These systems leverage longitudinal T-slot channels to enable flexible attachment of accessories, brackets, and connectors using slot-compatible hardware such as T-nuts and profile fasteners. Their modularity enables users to design and modify structural assemblies without welding, cutting, or custom machining.

While existing T-slot systems allow a wide range of configurations, conventional connection techniques rely heavily on manual alignment of discrete components and fastening elements. Basic brackets or corner connectors require multiple fasteners and careful positioning, which can increase assembly time and introduce misalignment. Although drop-in or twist-lock T-nuts have improved slot access, these methods still require users to manage multiple loose components during installation.

Moreover, many current framing connectors lack integrated alignment features or mechanical guidance structures, resulting in inconsistent engagement or suboptimal load transfer between connected members. In configurations requiring precise right-angle or multi-axis connections, these limitations can compromise rigidity, repeatability, and overall structural performance. There is also limited support for hidden fastener access, flush-mounting, or rapid disassembly in compact assemblies.

Accordingly, there is a need for an improved joining system for T-slot framing structures that provides guided engagement, enhanced structural integrity, and efficient assembly without sacrificing configurability. The present invention addresses these limitations by introducing a connection system featuring a dovetail engagement interface with integrated stop features and mechanical locking options. The system supports both single-channel and multi-channel configurations and is compatible with a wide range of rail sizes and slot geometries.

### SUMMARY OF THE INVENTION

The present invention relates to a modular connection system for structural framing components, and more particularly to a mechanically interlocking assembly that enables framing rails—such as extruded T-slot members or other channeled profiles—to be securely joined using an integrated dovetail engagement mechanism and fastener-based locking elements. The system provides a fast, robust, and reconfigurable connection suitable for use in structural frameworks, machine bases, enclosures, or industrial support assemblies.

In some embodiments, the connection system may include a first joining member secured to an end portion of a first framing rail and a second joining member secured along a surface or channel of a second framing rail. The first and second joining members interface through a dovetail mechanism, where one member includes a dovetail projection and the other includes a complementary dovetail receiver. The dovetail interface may be configured for linear sliding engagement and may include integrated stop features that limit travel and ensure proper alignment upon full insertion.

In some embodiments, the connection may be further reinforced using one or more mechanical fasteners. In certain embodiments, fasteners may pass through coaxially aligned through-holes in the joining members to form a rigid connection. Access to these fasteners may be provided through an unused slot or rear channel on the framing rail. Fasteners may include countersunk screws, cap head bolts, set screws, or other commercially available fasteners. The system may also accommodate blind hole mounting or side access installation, depending on the selected configuration.

The second joining member may include one or more mounting features configured to secure to standard or customized T-slot channels. Channel engagement may be achieved using T-nuts, sliding or rotating lock blocks, spring-loaded inserts, wedge-locks, or other retention mechanisms adapted to fit within the geometry of the channel. Mounting may occur along a single channel (single-channel configuration) or across multiple parallel channels (dual-channel or multi-channel configurations).

The system may be adaptable to various rail profiles and geometries, including industry-standard metric and imperial extrusion sizes. It may be scaled for compatibility with single-slot, dual-slot, or quad-slot framing systems, or with proprietary extrusions having alternative channel arrangements. The dovetail and mounting elements may be configured symmetrically or asymmetrically to accommodate corner joints, mid-span reinforcements, or load-bearing intersections.

The joining members may be fabricated from materials selected for strength, corrosion resistance, and manufacturability. Suitable materials include extruded aluminum, stainless steel, zinc alloy, or reinforced polymer composites. Manufacturing processes may include machining, extrusion, casting, or injection molding, depending on material and production volume requirements. Surface features such as chamfers, detents, alignment grooves, and anti-rotation tabs may also be incorporated to enhance assembly precision and repeatability.

The present invention may be particularly suited for modular assembly applications where ease of installation and structural integrity are both critical. It allows for rapid assembly and disassembly using standard hand tools and supports both permanent and reconfigurable installations. Because of its modularity and compatibility with off-the-shelf framing systems, the invention reduces both time and cost associated with building machine frames, robotic workstations, product displays, material handling carts, and architectural structures.

In some embodiments, the first joining member may be configured to mount to the end of a structural framing rail using threaded inserts, captive nuts, direct threading, or other mounting hardware. The second joining member may be configured to mount to a side or lateral surface of a second rail using a variety of channel engagement elements, including T-nuts, compression plates, wedge blocks, or other expansion-fit devices compatible with extruded profiles. The joining members may include recessed or countersunk fastener channels to enable flush installation and may be symmetrical or asymmetrical in geometry depending on the mounting configuration

In certain configurations, the system may also support multi-axis installations where three or more framing rails converge at a shared connection node. Variants may include provisions for rotational alignment, offset spacing, or integrated grounding paths for electrical continuity. Additionally, the invention may be implemented in environments requiring cleanroom compatibility, outdoor durability, or dynamic mechanical loading.

Accordingly, the present invention provides a flexible and scalable connection system that improves upon traditional fastening techniques for modular framing assemblies. It simplifies the assembly process, reduces alignment error, and enhances the strength and repeatability of structural connections using a guided dovetail interface and channel-based engagement hardware. The system enables consistent, tool-friendly construction of precision framing assemblies across a variety of industries and use cases.

It is an aspect of the present invention to provide a connection assembly for T-slot framing that may include a first member having a dovetail receiver and a stop receiver, and a second member having a dovetail projection and a stop feature. The dovetail projection may be operable to be received within the dovetail receiver, and the stop feature may be operable to engage with the stop receiver to limit travel of the second member relative to the first member. At least one securing element may be provided to fix the first and second members in place following engagement. The first member may be secured to a distal end of a first T-slot framing member, and the second member may be secured along a lateral length of a second T-slot framing member. The second member may further include at least one integrated fastener channel that may be configured to receive a T-nut or similar retention element. The securing element may include a fastener that may be inserted through a pair of coaxially aligned through-holes formed in the first and second members. The dovetail receiver may include a chamfered lead-in region to assist in sliding engagement with the dovetail projection. The stop feature may include a raised mechanical interference tab that may be operable to engage a recessed detent within the stop receiver. The dovetail projection and dovetail receiver may be configured for a friction-fit or interference-fit engagement depending on application-specific requirements.

It is another aspect of the present invention to provide a modular framing system that may include a plurality of T-slot framing rails, each of which may have one or more longitudinal T-slot channels, and a plurality of joining assemblies that may include a dovetail coupling interface, a set of fasteners, and T-nut or equivalent channel engagement members. Each joining assembly may be configured to connect a first framing rail to a second framing rail in a perpendicular or angular orientation. The system may be further configured to accommodate one-slot to quad-slot framing profiles through adjustment of T-nut count, spacing, and fastener alignment. At least one of the joining assemblies may include a stop feature that may limit sliding engagement between a dovetail projection and a dovetail receiver. The framing rails may include one or more through-holes intersecting a T-slot channel and may be configured to receive a fastener for anchoring a joining assembly. The T-nut engagement members may be preassembled with at least one of the joining assemblies to facilitate rapid field installation. Each joining assembly may include a first member having a dovetail receiver and a second member having a dovetail projection, and the members may be slidably engageable. The dovetail coupling interface may be operable for tool-less insertion and mechanical retention. The fasteners may include countersunk screws, bolts, or similar threaded hardware that may seat flush within the surface of the joining members. In some implementations, a framing rail may be vertically oriented and joined to a horizontally oriented framing rail using a single joining assembly. Additionally, a locking fastener may be included and may be accessible through an unused or auxiliary T-slot channel of one of the framing rails to secure the assembly after alignment

It is a further aspect of the present invention to provide a method of joining modular framing members that may include the steps of providing a first structural rail and a second structural rail, each of which may include at least one longitudinal engagement channel. A first joining component may be positioned adjacent to an end portion of the first structural rail and may be fastened to the rail using one or more mechanical fasteners that may be inserted through mounting apertures. A second joining component may be positioned adjacent to the engagement channel of the second structural rail. At least one channel-retaining fastener, such as a T-nut or locking insert, may be inserted into the engagement channel of the second structural rail, and the second joining component may be fastened using the inserted fastener. A dovetail projection formed on one of the joining components may be aligned with a complementary dovetail receiver formed on the other component. The components may then be slid together along a linear path until a stop feature provided on one of the components engages with a corresponding stop receiver. A locking fastener may then be inserted through aligned through-holes in the first and second joining components to restrict or prevent relative movement. The T-nut or equivalent retention element may be preassembled with the second joining component prior to insertion into the second structural rail. In some implementations, the locking fastener may be accessed through an unused or adjacent engagement channel of the framing rail. The dovetail projection and dovetail receiver may be dimensioned to provide an interference fit, a clearance fit, or a self-aligning frictional interface. The joining components may be aligned along a shared centerline axis to ensure proper fit before sliding engagement. The mechanical fasteners used for mounting may be countersunk or recessed to provide a flush outer surface upon final assembly

Further aspects and embodiments will be apparent to those having skill in the art from the description and disclosure provided herein.

It is, therefore, an object of the present invention, to provide a modular connection system that may allow for rapid, tool-assisted, or tool-free assembly of structural framing components with enhanced alignment precision and reduced installation time.

It is also an object of the present invention to provide a joining assembly, that may accommodate a range of rail geometries, slot configurations, and mounting orientations using standardized or application-specific fasteners and channel engagement elements.

It is also an object of the present invention to enable repeatable and reconfigurable structural connections using dovetail-based interfaces and slot-compatible retention hardware, thereby facilitating modular construction across various industrial, commercial, and architectural applications.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides an exploded perspective view of a T-slot rail assembly, according to an embodiment of the present invention.

FIG. 2 provides a close-up view of the T-slot rail joining assembly of FIG. 1, according to an embodiment of the present invention.

FIG. 3 provides a side view of a single channel quick connecting system, according to an embodiment of the present invention.

FIG. 4 provides a side view of a dual channel quick connecting system, according to an embodiment of the present invention.

FIG. 5 provides a second side view of a single channel quick connecting system, according to an embodiment of the present invention.

FIG. 6 provides a cross-sectional view of the single channel quick connecting system about the line FIG. 6-FIG. 6 shown in FIG. 5, according to an embodiment of the present invention.

FIG. 7 provides a second side view of a dual channel quick connecting system, according to an embodiment of the present invention.

FIG. 8 provides a cross-sectional view of the dual channel quick connecting system about the line FIG. 8-FIG. 8 shown in FIG. 7, according to an embodiment of the present invention.

FIG. 9 shows an exploded perspective view of a dual channel quick connecting system, according to an embodiment of the present invention.

FIG. 10 shows an exploded top view of a dual channel quick connecting system, according to an embodiment of the present invention.

FIG. 11 shows a side view of a T-slot framing rail, according to an embodiment of the present invention.

FIG. 12 provides an exploded view of a T-slot framing rail system assembly, according to an embodiment of the present invention.

FIG. 13 provides a close-up view of the T-slot framing rail system about the section of FIG. 12, according to an embodiment of the present invention.

FIG. 14 provides an exploded view of the T-slot framing rail system assembly, according to an embodiment of the present invention.

FIG. 15 provides a close-up view of the T-slot framing rail system about the section of FIG. 14, according to an embodiment of the present invention.

FIG. 16 provides a side view of the T-slot framing rail system assembly, according to an embodiment of the present invention.

FIG. 17 provides a close-up view of the T-slot framing rail system about the section of FIG. 14, according to an embodiment of the present invention.

FIG. 18 provides a front view of a first joining member of the T-slot framing rail system, according to an embodiment of the present invention.

FIG. 19 provides a front view of a second joining member of the T-slot framing rail system, according to an embodiment of the present invention.

FIG. 20 provides a perspective front view of a first joining member of the T-slot framing rail system, according to an embodiment of the present invention.

FIG. 21 provides a perspective view of a second joining member of the T-slot framing rail system, according to an embodiment of the present invention.

FIG. 22 provides a perspective view of a T-nut, according to an embodiment of the present invention.

FIG. 23 provides a perspective view of a T-nut, according to an embodiment of the present invention.

FIG. 24 provides a side view of both a short and elongated T-nut, according to an embodiment of the present invention.

FIG. 25 provides an exemplary perspective view of a frame assembly constructed from a plurality of structural members joined together using the quick connection system, according to an embodiment of the present invention.

FIG. 26 provides a close-up view of a corner of the frame assembly about the section of FIG. 25, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

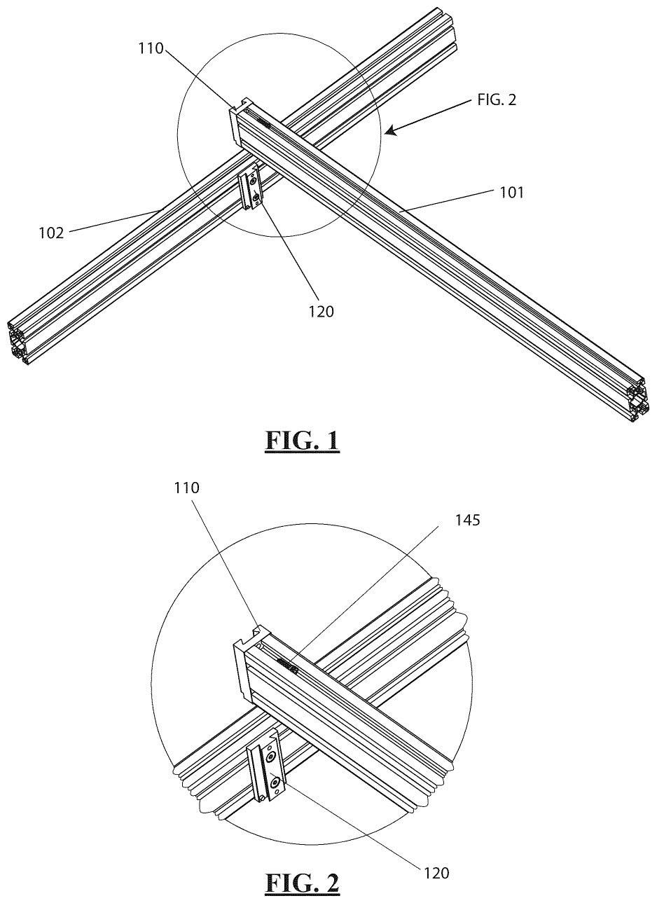

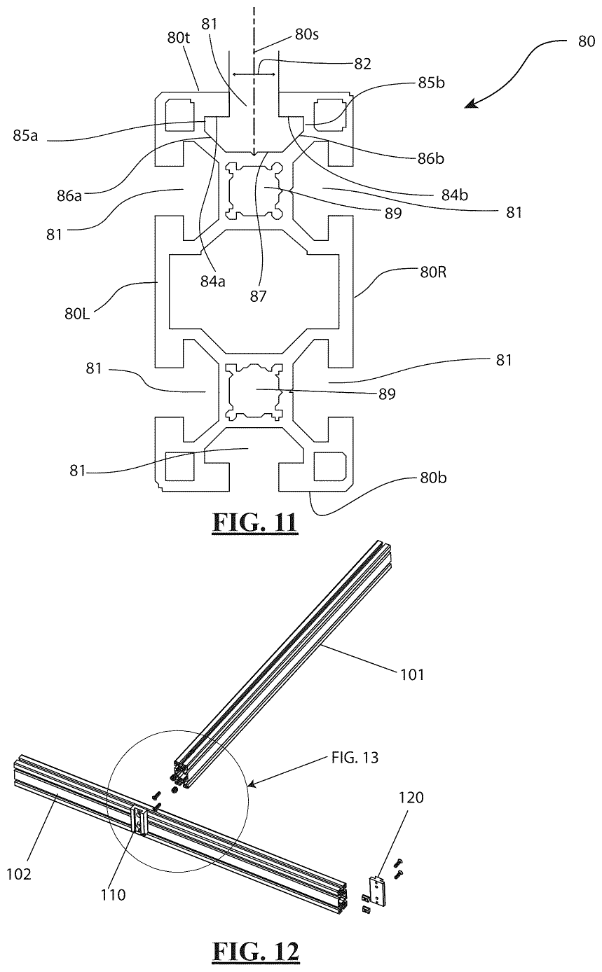

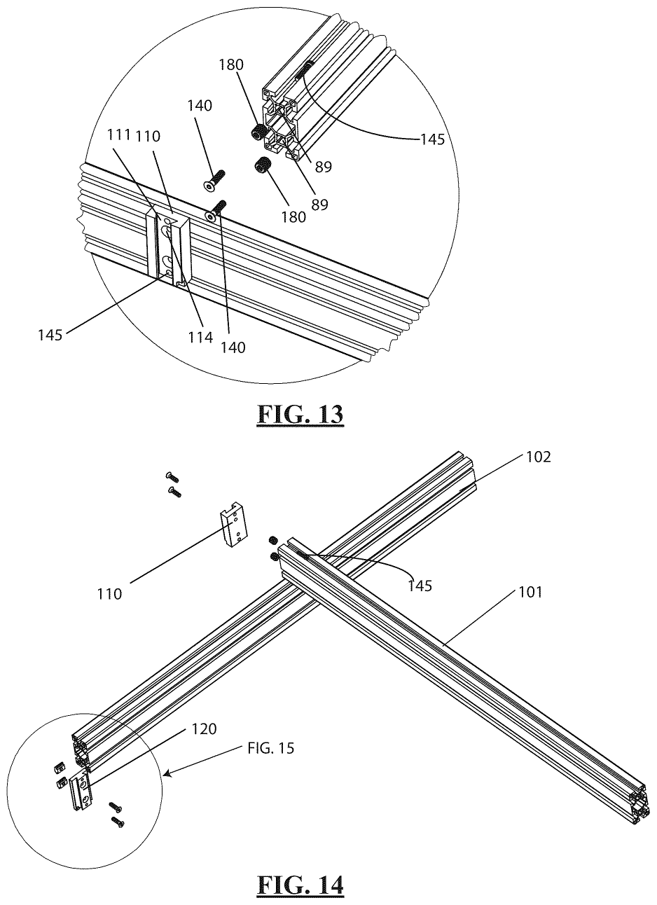

Referring to the drawings, wherein like reference characters designate like or corresponding parts throughout the several views, and referring particularly to FIGS. 1-26, it is seen that the present invention contains various views of a modular joining mechanism for T-slot framing systems and a quick connection system that is operable to connect T-slotted framing rails together into a structure.

In accordance with various embodiments of the present disclosure, a quick connection system 100 is provided. The quick connection system 100 includes a first joining member 110 operatively configured to engage with a second joining member 120 via a dovetail sliding interface. The first joining member 110 and second joining member 120 are each structured to be mechanically coupled to discrete structural framing elements, such as T-slot frame extrusions, which are adapted to receive and support a plurality of accessory components. The T-slot frame extrusions may comprise profiles having one or more longitudinal channels, including but not limited to single-slot, dual-slot, triple-slot, and quad-slot configurations.

In some embodiments, the joining members may be machined, extruded, or injection-molded from rigid materials such as aluminum, steel, reinforced polymer, or composite material. The system may be implemented using standard T-slot rail hardware or custom-configured rail sections compatible with the engagement geometry described herein.

The quick connection system 100 may be embodied in at least two primary configurations: a single-channel engagement variant 100A and a dual-channel engagement variant 100B. It is contemplated that the dual-channel variant 100B may be scalable to accommodate triple-slot, quad-slot, or multi-channel framing profiles by the incorporation of additional mechanical fasteners, T-nuts, and aligned structural support features such as through-holes and parallel engagement channels. A person of ordinary skill in the art will appreciate that the number, placement, and orientation of the dovetail interfaces and T-slot fastener channels may be adapted based on loading conditions, connection directionality, and rail geometry without departing from the principles of the invention.

For purposes of illustration and without limiting the scope of the invention, the exemplary embodiments described herein are referenced with respect to a 1×2 T-slot framing rail 80 profile, wherein the framing rail comprises a single T-slot channel 81 disposed along both an upper 80t and lower surface 80b, and a pair of opposing T-slot channels 81 disposed along lateral right 80R and left side 80L surfaces, as further depicted in FIG. 11. The foregoing description is intended to be illustrative and not restrictive, and it will be understood by those of ordinary skill in the art that variations and modifications may be made without departing from the scope of the present invention.

As illustrated in FIG. 11, the T-slot framing rail 80 may include a plurality of T-slot channels 81, each having a substantially uniform or identical slot profile. Dimensions of the T-slot channel 81, including the width of the neck 82, depth of the internal cavity, and thickness of the retention lips 84a and 84b, may be varied according to industry-standard rail profiles such as 20×20 mm, 30×30 mm, or 1×2 inch profiles, or may be customized to accommodate proprietary or application-specific fasteners. In such embodiments, the cross-sectional profile of each T-slot channel 81 defines an internal cavity that is bilaterally symmetrical about a central reference axis 80s. The cavity extends inwardly from a narrow neck opening 82 located at the exterior surface of the framing rail. The neck 82 is bounded on opposite lateral sides by a pair of retention lips (84a, 84b), which operate to retain a fastener element (e.g., a T-nut) within the internal cavity and prevent unintended dislodgement during assembly or use. Extending from the respective retention lips (84a, 84b) are a pair of opposing vertical channel walls (85a, 85b), which terminate at corresponding chamfered surfaces (86a, 86b) (e.g., guided surfaces). These chamfered surfaces facilitate the insertion and alignment of fastener components into the cavity. The internal cavity is terminated by a back wall surface 87, which defines the maximum depth of the channel. As illustrated in FIG. 24, the short T-nut 162 and the elongated T-nut 161 may have the same cross-sectional profile 120p, which is substantially complimentary to the cross-sectional profile of each T-slot channel 81.

In some embodiments, one or more through holes 89 may be formed within the T-slot framing rail 80. These through holes may be positioned adjacent to or intersecting the back wall surfaces of the left-side and right-side T-slot channels, and may similarly be positioned adjacent to the back wall of the top and bottom T-slot channels. These through holes 89 may be configured to receive fastening elements or tools for accessing internally retained fasteners or for creating perpendicular joints with other structural members.

In alternative configurations, the internal cavity of the T-slot channel 81 may be defined by a continuous arcuate or curved surface, rather than by discrete walls and chamfered features. For example, in some embodiments, the corners or transitions within the cavity may be radiused, thereby reducing stress concentrations and facilitating smoother insertion of mating hardware. Such alternative internal cavity shapes may be formed using extrusion dies or precision machining, and remain fully compatible with the mechanical joining system described herein, provided the dovetail and fastener alignment features are maintained.

Turning to FIG. 1, a first joining member 110 is coupled to one end of a first framing member 101, the first joining member 110 being secured to the framing member 101 using the through-holes 89, and a second joining member 120 being secured along a lateral side of a second framing member 101, using a pair of short T-nuts 161 that engage with the lateral T-slot channels 81. The joining members may be secured using hand tools, such as Allen wrenches or torque drivers, and assembly can typically be completed in under two minutes per joint by a technician without specialized training. It is seen in FIG. 2 that the first and second joining members may be slidably removed and inserted.

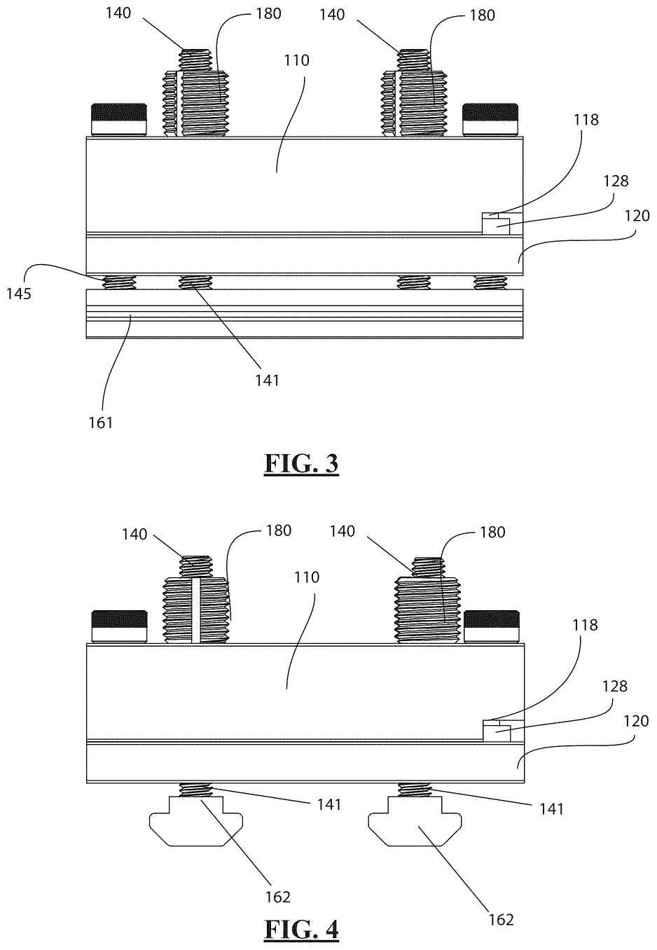

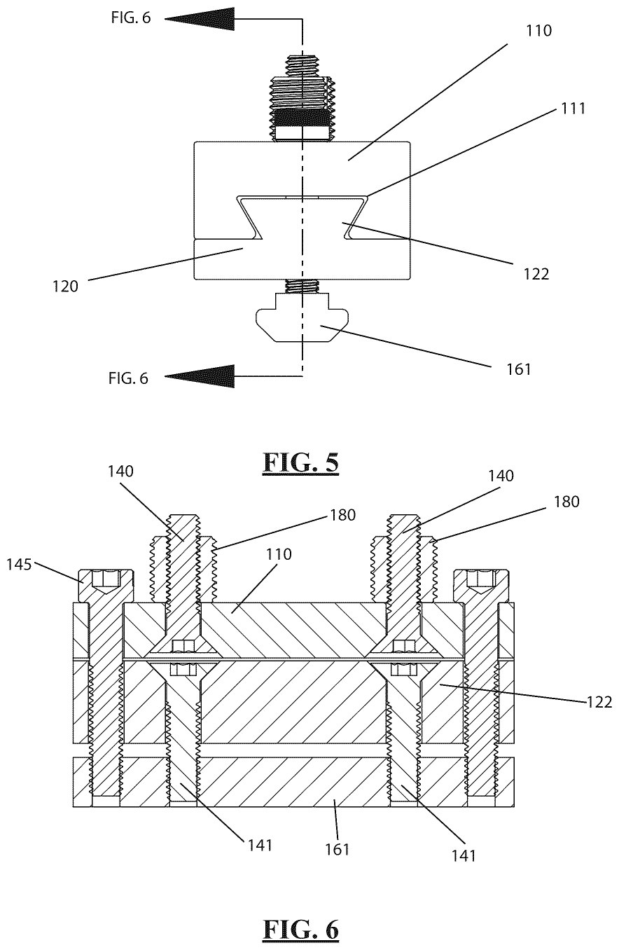

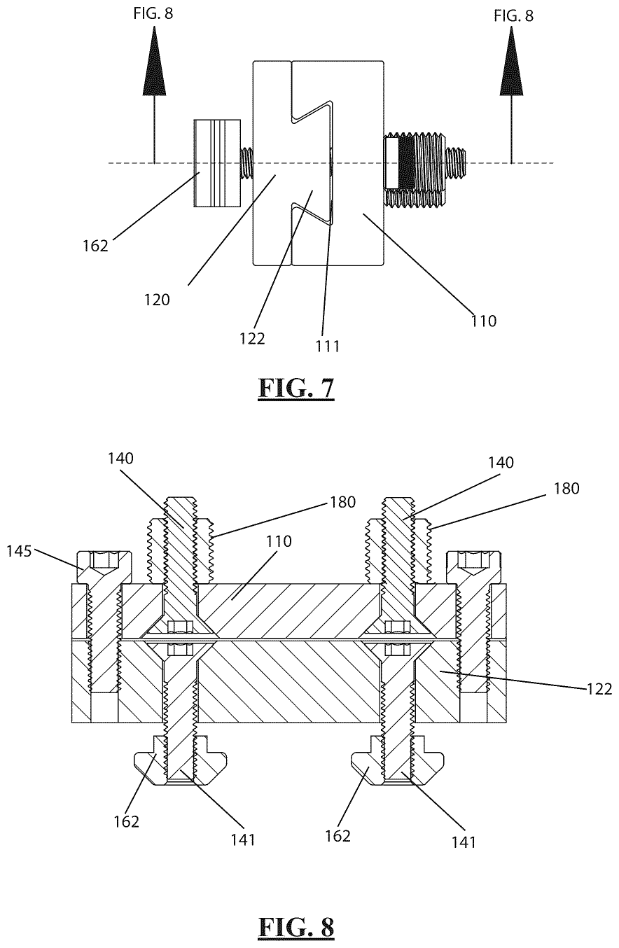

FIG. 3 provides a side view of a single-channel variant 100A, and FIG. 4 illustrates a side view of a dual-channel variant 100B. In some embodiments, the first joining member 110 and second joining member 120 for both the single channel and dual channel variants are identical, which is clearly illustrated in comparing the cross-sectional views of FIG. 6 and FIG. 8. In such embodiments, configuring the quick connection system 100 for a single channel, an elongated T-nut 161 may be secured to the second joining member, and to configure the quick connection system 100 for a dual channel, a pair of short T-nuts 162 are secured, to the second joining member.

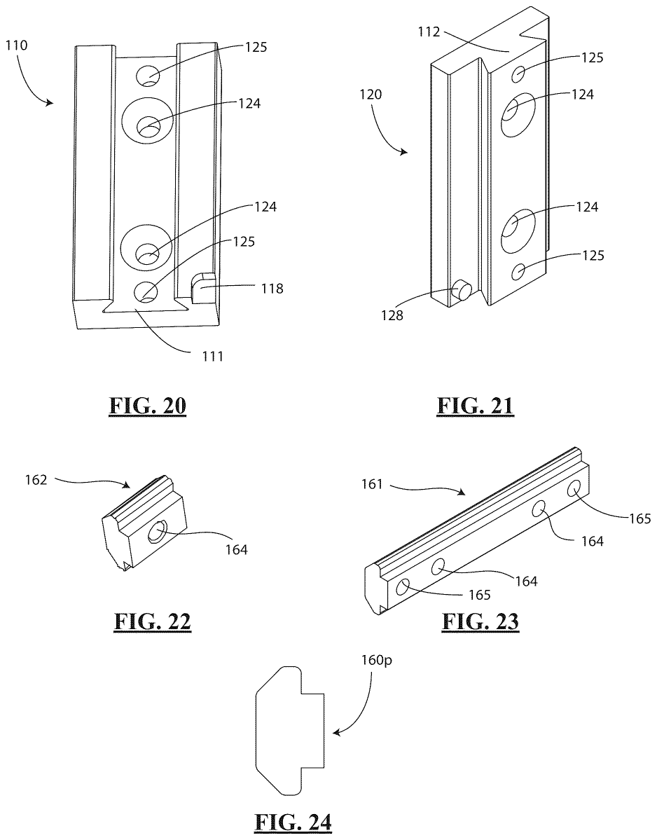

As illustrated in FIGS. 18 and 20, the first joining member 110 may include a pair of countersunk through holes 114 and a pair of securing through holes 115 along the centerline of the joining member, a dovetail receiver 111, and a stop receiver 118 on a distal end 110d. In some embodiments, the countersunk through holes 114, may be a threaded bore and receive a fastener that is flush with dovetail receiver 111 engagement surface. As illustrated in FIGS. 19 and 21, the second joining member 120 may include a pair of countersunk through holes 124, a pair of securing through holes 125, a stop feature 128 on a distal end 120d, and a dovetail 112 extending from the front surface. To secure the second joining member 120 to the first joining member 110, a user may position the distal end 110d of the first joining member 110 with a proximal end 120p of the second joining member and may align the dovetail receiver 111 with the dovetail 112 and may slide the dovetail receiver 111 of the first joining member 110 over the dovetail 112 until the stop feature 128 engages with the stop receiver 118, and the proximal end 110p of the first joining member 110 is flush with the proximal end of the second joining member 120p, as clearly illustrated in FIGS. 3 and 4. In some embodiments, the countersunk through holes 124, may be a threaded bore and receive a fastener that is flush with dovetail 112 engagement surface. The geometry and depth of the dovetail 112 and dovetail receiver 111 may be selected to allow for both a frictional fit and guided self-alignment. A clearance fit or interference fit may be selected depending on whether the connection is to be semi-permanent or reconfigurable.

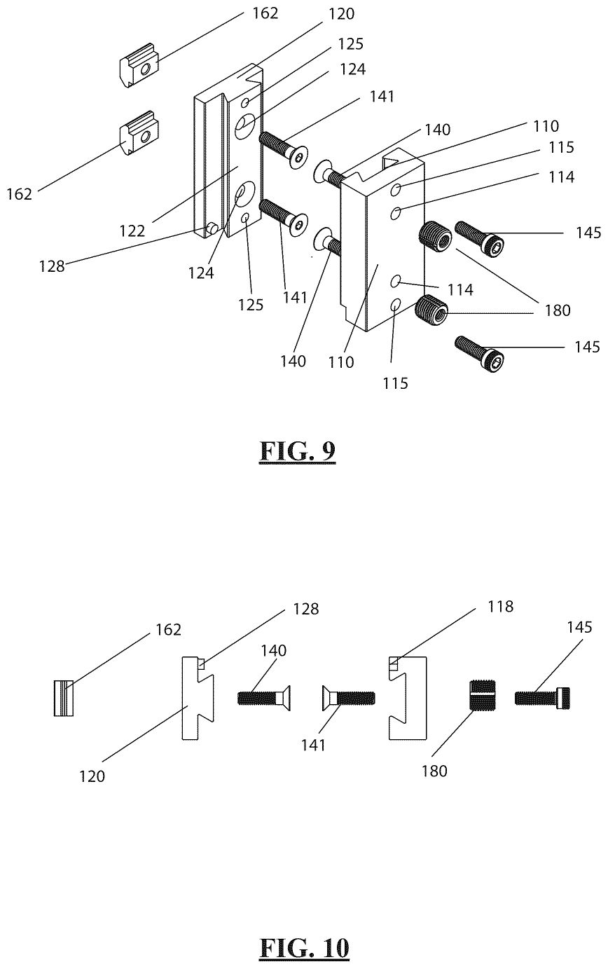

In assembly, the first joining member 110 may secure to an end of a framing member 101 with a pair of threaded inserts 180 that are secured to the through-holes 89 of the framing member 101. The countersunk through holes 114 may align with the threaded inserts 180, and the countersunk bolts 140 are advanced through the interior threading of the inserts 180 and flush with the surface of the dovetail receiver 111, as illustrated in FIGS. 9, 10, and 13.

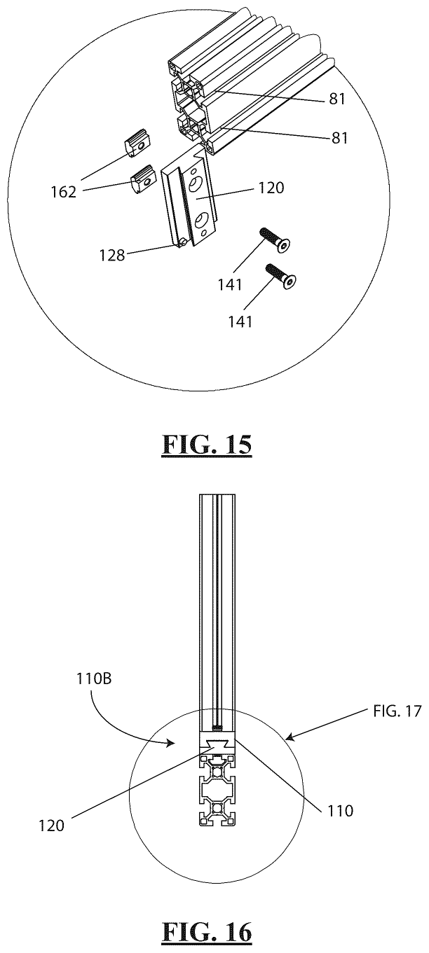

For a dual channel configuration, as illustrated in FIG. 15, the second joining member 120 may secure along the length of the framing member using a pair of the short T-nuts 162 each corresponding to a lateral T-slot channel 81 and the countersunk fasteners 141 may be advanced through the countersunk holes 124 and engage with the short T-nut 162 fastener receiver 164. In some embodiments, the second joining member 120, short T-nut 162, and countersunk fasteners 141 may be preassembled before alignment with the T-slot channels 81. As illustrated in FIG. 8, once the first joining member 110 and second joining member 120 are aligned, a securing fastener 145 is advanced through the first securing through hole 115 and the second securing through hole 125 of each joining member, respectively, to fix the framing members together. The securing fastener 145 may be accessed through an unused T-slot channel 81 as shown in FIG. 13.

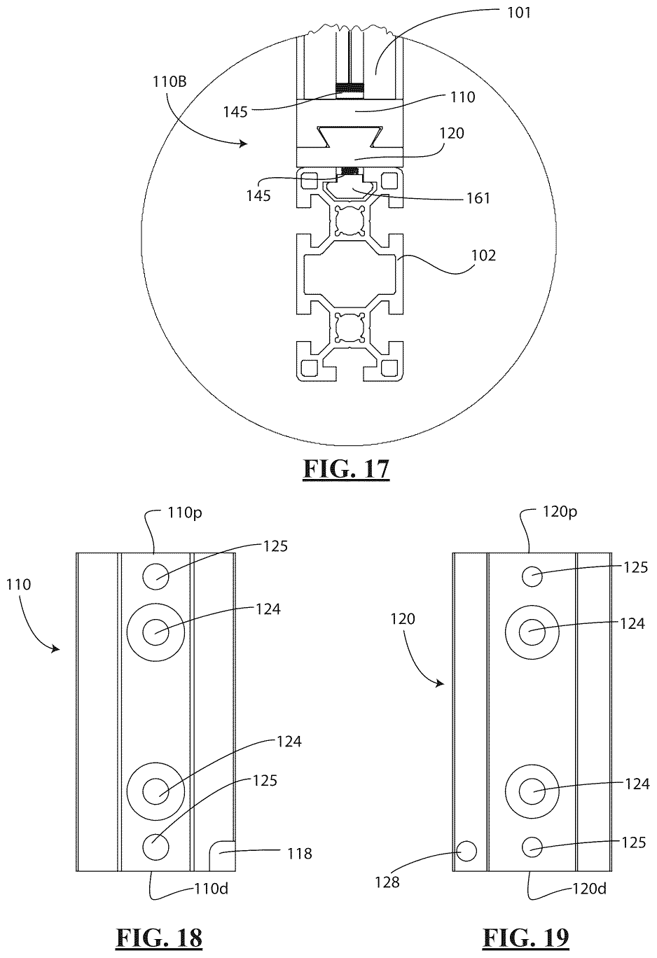

For a single channel configuration, as illustrated in FIGS. 6 and 17, the second joining member 120 may secure along the length of the framing member using an elongated T-nuts 161 corresponding to a T-slot channel 81 on either the top 80t or bottom 80b. The countersunk fasteners 141 may be advanced through the countersunk holes 124 and engage with the elongated T-nut 162 fastener receiver 164. As illustrated in FIG. 6, once the first joining member 110 and second joining member 120 are aligned, a securing fastener 145 is advanced through the first securing through hole 115, the second securing through hole 125 and the elongated T-nut through hole 165, to fix the framing member together. The securing fastener 145 may be accessed through an unused T-slot channel 81 as shown in FIG. 17. While the embodiment shown uses an elongated T-nut 161 for single-channel engagement, in other embodiments, a pair of short T-nuts 162 may be aligned within the same T-slot channel to achieve equivalent fastening strength and positioning accuracy.

The assembly process described herein may be performed in either vertical or horizontal orientation, and components may be preassembled offsite for rapid field deployment. The invention may be implemented in applications such as machine frames, automation systems, shelving units, enclosures, or any environment requiring modular structural connections. The system is particularly well suited for scenarios where reconfigurability, rapid deployment, and mechanical strength are priorities.

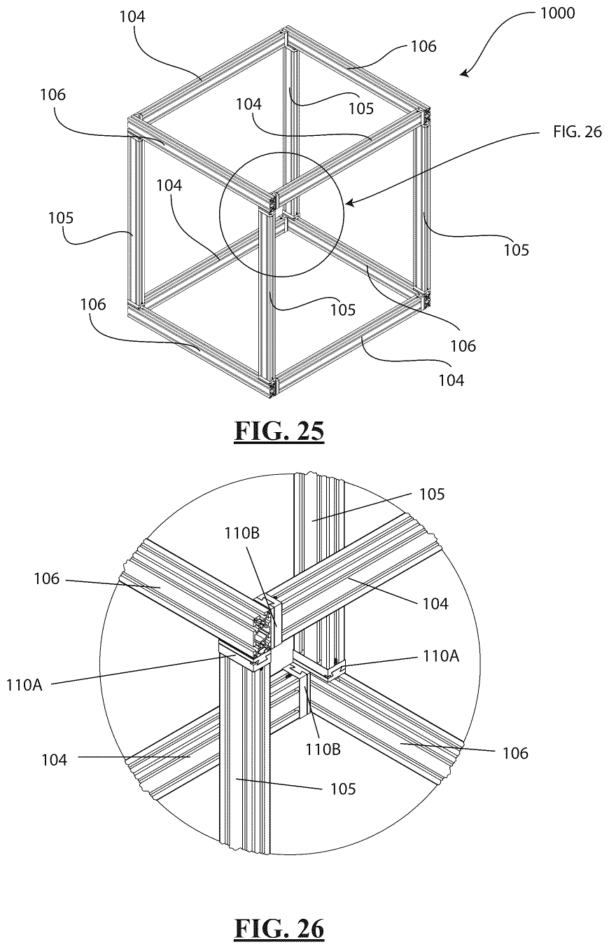

As illustrated in FIG. 25, a plurality of vertical framing members 105, horizontal members 104, and cross members 106 may be assembled to construct a modular frame 1000. Each of said members may be coupled using various configurations of the quick connection system 100 described herein. In one exemplary embodiment, and referring now to FIG. 26, a horizontal member 104 may be secured to a cross member 106 using the dual-channel engagement variant 100B, wherein a pair of lateral T-slot channels are engaged using two T-nuts and corresponding fasteners. Simultaneously, a vertical member 105 may be secured to the same cross member 106 using the single-channel engagement variant 100A, wherein a dovetail projection engages a dovetail receiver and is retained using a single centrally located T-slot.

Each of these connections may be implemented using standard T-slot hardware and may be assembled using basic hand tools in the field. The structural frame 1000 may be configured for use in industrial enclosures, automation frameworks, material handling carts, or other modular support structures where rapid assembly and reconfiguration are desired.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed is:

1. A connection assembly for T-slot framing, the assembly comprising:
a. a first joining member having a dovetail receiver and a stop receiver;
b. a second joining member having a dovetail projection and a stop feature, wherein the dovetail projection is operable to be received within said dovetail receiver, wherein said stop feature is operable to engage with said stop receiver to limit travel of said second member relative to said first member; and
c. at least one securing element operable to fix said first and second joining members in place after engagement;
wherein said first joining member is secured to a distal end of a first T-slot framing member, and said second joining member is secured along a lateral length of a second T-slot framing member.

2. The assembly of claim 1, wherein said second joining member further comprises at least one integrated fastener channel configured to receive a T-nut.

3. The assembly of claim 1, wherein said securing element comprises a fastener inserted through a pair of coaxially aligned through-holes formed in said first and second members.

4. The assembly of claim 1, wherein said dovetail receiver comprises a chamfered lead-in region to facilitate sliding engagement with said dovetail projection.

5. The assembly of claim 1, wherein said stop feature comprises a raised mechanical interference tab operable to engage a recessed detent formed in said stop receiver.

6. The assembly of claim 1, wherein said dovetail projection and dovetail receiver are configured for a friction-fit connection.

7. A modular framing system, the system comprising:
a. a plurality of T-slot framing rails, each having one or more longitudinal T-slot
channels;
b. a plurality of joining assemblies each including a dovetail coupling interface,
a set of fasteners, and T-nut engagement members;
c. wherein each joining assembly is configured to connect a first framing rail to a second framing rail in a perpendicular orientation;
d. and wherein the system is configurable to accommodate one-slot to quad-slot framing profiles through adjustment of T-nut quantity and fastener alignment.

8. The system of claim 7, wherein at least one of said joining assemblies includes a stop feature operable to limit sliding engagement between a dovetail projection and a dovetail receiver.

9. The system of claim 7, wherein said framing rails include at least one through-hole intersecting a T-slot channel and configured to receive a fastener that engages a joining assembly.

10. The system of claim 7, wherein said T-nut engagement members are preassembled with at least one of said joining assemblies.

11. The system of claim 7, wherein each joining assembly comprises a first member having a dovetail receiver and a second member having a dovetail projection, and said members are slidably engageable.

12. The system of claim 7, wherein said dovetail coupling interface is configured for tool-less sliding insertion and mechanical retention.

13. The system of claim 7, wherein said fasteners comprise countersunk screws seated flush within said joining assembly.

14. The system of claim 7, wherein at least one of said T-slot framing rails is oriented vertically and joined to a horizontally oriented framing rail via said joining assembly.

15. The system of claim 7, wherein at least one joining assembly includes a locking fastener accessible through an unused T-slot channel of one of said framing rails.

16. A method of joining modular framing members, the method comprising:
a. providing a first structural rail and a second structural rail, each comprising at least one longitudinal engagement channel;
b. positioning a first joining component adjacent to an end portion of said first structural rail and fastening said first joining component to said first structural rail using one or more mechanical fasteners inserted through mounting apertures;
c. positioning a second joining component adjacent to said longitudinal engagement channel of said second structural rail;
d. inserting at least one channel-retaining fastener, into said longitudinal engagement channel of said second structural rail, and fastening said second joining component to said second structural rail using said channel-retaining fastener;
e. aligning a dovetail projection formed on one of said joining components with a complementary dovetail receiver formed on the other of said joining components; and
f. sliding said joining components along a linear path until a stop feature integrated into one of said joining components mechanically engages with a corresponding stop receiver.

17. The method of claim 16, further comprising the step of inserting a locking fastener through aligned through-holes in said first and second joining components to secure said components together and restrict relative movement therebetween.

18. The method of claim 16, wherein said T-nut is preassembled with said second joining component prior to insertion into said side channel.

19. The method of claim 16, wherein said locking fastener is inserted through an unused engagement channel of said second structural rail.

20. The method of claim 16, wherein said dovetail projection and dovetail receiver are dimensioned to form a mechanical interference fit.

21. The method of claim 16, further comprising the step of aligning said joining components along a shared centerline axis prior to sliding engagement.

22. The method of claim 16, wherein said mechanical fasteners are countersunk to form a flush outer surface with said joining components.
